(19) United States
(12) Patent Application Publication
(10) Pub. No.: US 2017/0361927 A1
(43) Pub. Date: Dec. 21, 2017

(54) DRONE COMPRISING LIFT-PRODUCING WINGS

(71) Applicant: PARROT DRONES, Paris (FR)

(72) Inventors: Gauthier Lavagen, Rosny Sous-Bois (FR); Marc MARI MARI, Paris (FR); Yoni BENATAR, Les Lilas (FR); Thomas BARSE, Saint-Germain-en-Laye (FR)

(21) Appl. No.: 15/628,402

(22) Filed: Jun. 20, 2017

(30) Foreign Application Priority Data
Jun. 20, 2016 (FR) 1655738

(51) Int. Cl. B64C 27/26; B64C 3/32; B64C 39/02; B64C 39/08; B64C 11/46; B64C 29/00

(52) U.S. Cl. CPC B64C 27/26; B64C 11/46; B64C 29/0025; B64C 39/024; B64C 39/08; B64C 3/32; B64C 2201/088; B64C 2201/02; B64C 2201/104; B64C 2201/108; B64C 2201/146; B64C 2201/165; B64C 2201/187; B64C 2201/042

(57) ABSTRACT

A rotary-wing drone includes a drone body that includes an electronic board controlling the piloting of the drone, and four link arms that include a rigidly connected propulsion unit. The link arms form lift-producing wings.

### CROSS REFERENCE TO RELATED APPLICATIONS

This application claims priority under 35 U.S.C. §119(a) to French Patent Application Serial Number 1655738, filed Jun. 20, 2016, the entire teachings of which are incorporated herein by reference.

### BACKGROUND OF THE INVENTION

### Field of the Invention

The invention relates to leisure drones, in particular rotary-wing drones such as quadcopters and similar.

### Description of the Related Art

Flying drones include in general a drone body and one or more propulsion units mounted at the end of link arms, each propulsion unit being provided with a propeller driven by an individual motor. The different motors can be controlled in a differentiated manner in order to control the attitude and speed of the drone. An example is the Rolling Spider™ marketed by Parrot Drones SAS, Paris, France.

Each propeller exerts traction on the drone due to the lift of the propeller, with this traction being directed upwards, and a torque that is in the opposite direction to the rotational direction thereof. In stationary flight, i.e. when it is seemingly being kept motionless in altitude and attitude, the four propellers rotate at the same speed and the four lift forces are combined and compensate for the weight of the drone. In terms of the torques of the propellers, they cancel each other out due to the opposing rotational directions of the propellers.

This drone particularly can be provided with an accessory formed by a shaft provided with a large-diameter wheel on each of the ends thereof. This configuration particularly allows the drone to not only fly but also, since it is provided with wheels, to be driven on the ground, along a wall, against a ceiling, etc., thus increasing the possibilities of movement, in addition to the normal free flight and lift configurations of the drone.

However, this type of drone is limited in terms of the application thereof, since it allows either quadcopter flight, i.e. rotary-wing flight, or a rolling movement when it is provided with accessories.

In the field of scale models, a number of aircraft-type flying devices are known which do not allow flight by lift and rotary-wing propulsion, but flight assured by a thruster and for which lift is provided by the lift-producing wings of said aircraft. The aircraft are therefore considered fixed-wing apparatuses.

However, it is noted that said scale models are difficult to pilot and are often subject to crashes that damage the scale model.

### BRIEF SUMMARY OF THE INVENTION

The object of the invention is to propose a rotary-wing drone that allows a drone of this kind to fly not only using the lift of the rotational surfaces, namely the rotary wings, but also to fly like an aircraft using a fixed wing, while benefiting from the easy control offered nowadays by drones.

For this purpose, the invention proposes a rotary-wing drone comprising a drone body that comprises an electronic board controlling the piloting of the drone, and four link arms comprising a rigidly connected propulsion unit, the link arms forming lift-producing wings.

In a characteristic manner, the drone comprises flight conversion means allowing the drone to perform a conversion after take-off in order to fly using the lift of the four wings.

According to various subsidiary features, taken alone or in combination:

the propulsion units are fixed to the end of the lift-producing wings;

the four propulsion units form an angle of inclination relative to the horizontal median plane of the drone body when the drone is in the aircraft flight position, the propulsion units situated on either side of the drone body above the horizontal median plane of the drone body when the drone is in the aircraft flight position are each inclined towards the propulsion units situated on the same side of the drone body below said horizontal median plane at a positive predetermined vertical angle of inclination, and the propulsion units situated on either side of the drone body below said horizontal median plane are each inclined towards the propulsion units located on the same side of the drone body above the horizontal median plane at a symmetrical negative predetermined vertical angle of inclination;

the predetermined angles of inclination are identical as an absolute value;

the predetermined angles of inclination are between 10° and 30° as an absolute value;

the lift-producing wings positioned on each side of the drone body defined by the horizontal median plane are symmetrical;

the lift-producing wings are dihedral-shaped;

the lift-producing wings are made up of two portions, a first horizontal portion when the drone is in the aircraft flight position and a portion forming a junction between the horizontal wing section and the drone body;

the lift-producing wings positioned on each side of the drone body are interconnected by at least one reinforcement means;

the reinforcement means is fixed substantially close to the propulsion units;

the lift-producing wings form a sweep angle relative to the drone body;

the drone body is of elongate shape and is substantially perpendicular to the plane of the propellers;

the drone body comprises an ultrasonic sensor and/or a camera sensor directed substantially perpendicularly to the plane of the propellers;

the drone is devoid of a wing control surface;

at least one wing of the drone comprises at least one stiffening means over at least one portion of the periphery of the wing;

said at least one stiffening means is located at least in part on the distal end and/or on the trailing edge of said at least one wing;

said at least one stiffening means is located at least on the junction portion between the distal end and the trailing edge of said at least one wing;

said at least one stiffening means is located at least in part on the distal end of said at least one wing and extends beyond said distal end so as to form a support element for the drone;

each wing of the drone comprises said stiffening means.

### BRIEF DESCRIPTION OF THE SEVERAL VIEWS OF THE DRAWINGS

An embodiment of the present invention will now be described with reference to the accompanying drawings.

FIG. 1 is a general view of the drone according to the invention seen from above when the drone is on the ground.

FIG. 2 is a side view of the drone according to the invention when the drone is in flight using the lift of the wings.

FIG. 3 is a view from above of the drone according to the invention when the drone is in flight using the lift of the wings.

FIG. 4 is a rear view of the drone according to the invention when the drone is in flight using the lift of the wings.

FIG. 5 shows a particular embodiment of the drone according to the invention.

FIG. 6 shows a further particular embodiment of the drone according to the invention.

### DETAILED DESCRIPTION OF THE INVENTION

An embodiment of the invention will now be described.

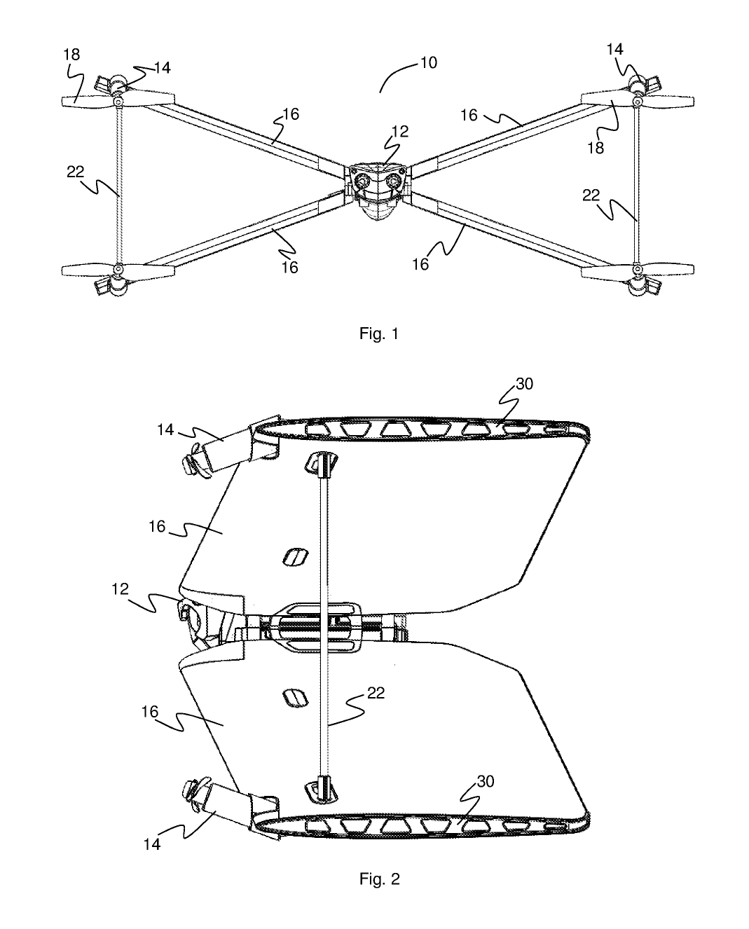

In FIG. 1, reference sign 10 generally designates a rotary-wing drone. In the example shown in FIG. 1, it is a quadcopter-type drone derived from the Rolling Spider model marketed by Parrot Drones SAS, Paris, France.

The quadcopter drone includes a drone body 12 and four propulsion units 14 rigidly connected to the four link arms 16, respectively. The propulsion units 14 are independently controlled by an integrated navigation and attitude control system. Each propulsion unit 14 is equipped with a propeller 18 driven by an individual motor. The different motors can be controlled in a differentiated manner in order to pilot the attitude and speed of the drone and with the production of positive lift.

The propellers 18 on two propulsion units rotate in the clockwise direction and the propellers on the other two propulsion units rotate in the anti-clockwise direction. The propulsion units equipped with propellers rotating in the same direction of rotation are positioned on the same diagonal line.

In a manner that is characteristic of the invention, the four link arms 16 form lift-producing wings, substantially perpendicular to the plane of the propellers, allowing the drone to fly either using the rotary wings or in so-called aircraft flight, so as to benefit from the lift of the lift-producing wings.

According to a particular embodiment, the propulsion units are secured substantially to the end of the lift-producing wings as shown in FIG. 1.

Alternatively, the propulsion units may be secured over almost the entire length of the lift-producing wings, notably in the region of the leading edge of each of the wings; however a minimum distance between two adjacent propulsion units should be respected, and said distance should not be less than the sum of the radii of the two propellers on said adjacent propulsion units.

According to a particular embodiment, the drone comprises flight conversion means allowing the drone to effect a conversion after take-off in quadcopter mode, i.e. using the lift of the rotational surfaces, so that the drone flies using the lift of the wings, and particularly the drag of the wings of said drone.

To do this, the drone effects a conversion of a given angle, namely an angle □ of from for example 20° to 90°, and preferably a pitch angle □ of between 20° and 80°, such that the drone benefits from the lift of the four wings in order to fly. Thus, the drone is suitable for flying conventionally using the lift of the rotational surface or like an aircraft using the lift of the wings. This type of drone has the advantage of being suitable for flying like an aircraft, but allows good control of the flight speed, as said drone is also suitable for flying very slowly, notably if the conversion angle is a small angle.

Therefore, the user of the drone that is the subject matter of the present invention can fly the rotary-wing drone conventionally or like an aeroplane, as they so desire, whilst benefiting from the ease of piloting currently provided by the drone.

If the drone is defined before take-off according to the three orthogonal axes X, Y and Z, said axes will then be named:

X axis, the roll axis which is defined by the fact that a rotation of the drone on this axis allows the drone to be moved to the right or to the left,

Y axis, the pitch axis which is defined by the fact that a rotation of the drone on this axis allows the drone to be moved forwards or backwards, and

Z axis, the yaw axis or heading axis, which is defined by the fact that a rotation of the drone on this axis has the effect of making the main axis of the drone pivot to the right or to the left; thus, the direction of forward movement of the drone.

Thus, the conversion can be defined by the fact that the Z axis of the drone, corresponding to the heading axis during drone flight in conventional mode, i.e. using the lift of the rotary wing, becomes the roll axis when the drone transitions into aircraft flight mode, i.e. using the fixed wing, in other words the lift of the four wings.

The drone shown in FIG. 1 comprises four link arms in the form of lift-producing wings; however, such a drone can comprise more than four lift-producing wings.

According to a particular embodiment, the drone body 12 is of elongate shape, for example. According to this embodiment, the lift-producing wings of the drone are fixed over all or part of the length of the drone body.

The drone shown in FIG. 1 is such that the lift-producing wings 16 are positioned on each side of the drone body defined by the horizontal median plane of the drone body 12 when the drone is in the aircraft flight position, and the lift-producing wings are symmetric and form a dihedral, for example.

According to another embodiment, the lift-producing wings on either side of the drone body may not be symmetric relative to said horizontal median plane of the drone body.

It can also be seen that the drone shown in FIG. 1 is such that the lift-producing wings 16 are situated on either side of the drone relative to the vertical median plane 12 when the drone is in the aircraft flight position and the lift-producing wings are symmetric.

According to another embodiment, the lift-producing wings on either side of the drone body may not be symmetric relative to said vertical median plane of the drone body.

The structure of the drone as shown in FIG. 1 is X-shaped having a positive dihedral angle on the upper wings relative to the horizontal median plane of the drone body when the drone is in the aircraft flight position, and a negative dihedral angle of the same value on the lower wings relative to said horizontal median plane. However, the drone may comprise positive and negative dihedral angles of different values.

For example, the positive dihedral angle on the upper wings is between 15° and 25°, and preferably 20°. Similarly, in accordance with the drone illustrated, the negative dihedral angle on the lower wings is between 15° and 25°, and preferably 20°.

According to a particular embodiment that is particularly shown in FIG. 6, the drone structure is such that the dihedral angle is zero.

As can be seen in FIG. 1, the lift-producing wings have a wingspan such that the lever arm allows stable flight in aircraft mode. In the example illustrated in FIG. 1, the wingspan is 30 cm.

Furthermore, the lift-producing wings have a lift surface appropriate for allowing the drone to fly in aircraft mode using the lift of the four wings. The surface of the wings is determined so as to offer good lift without having a major impact on the flight performance of the drone in conventional flight.

The lift-producing wings are made of for example polystyrene, polypropylene (PP) or expanded polypropylene (EPP) or another type of expandable polyolefin.

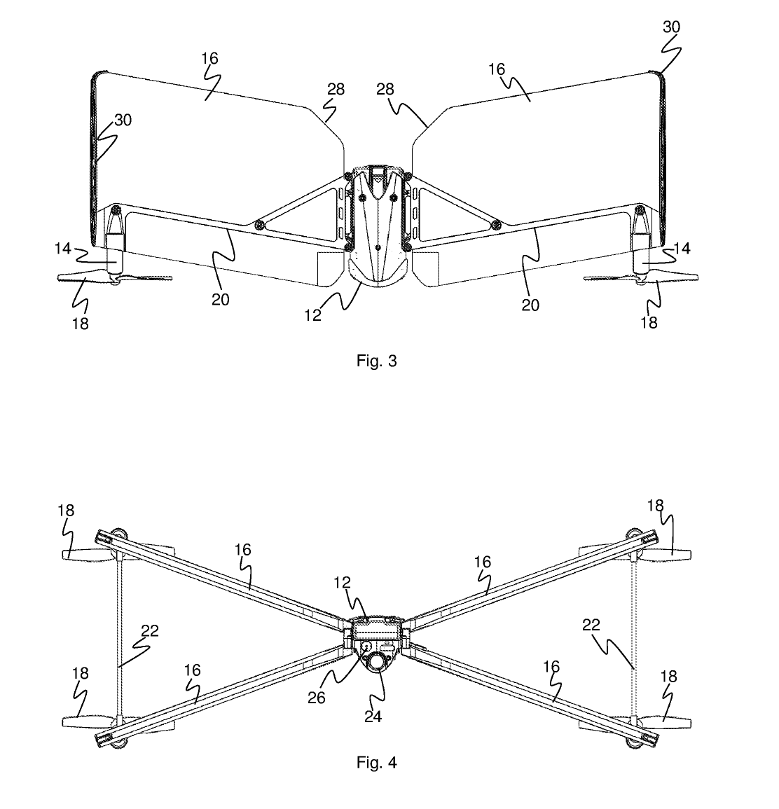

As shown in FIG. 3, each lift-producing wing can comprise at least one structural element 20 inserted into the lift-producing wing. This structural element 20 can be more or less flexible according to the stiffening requirements of the wing. The structural element can allow the routing of the one or more electric wire(s) connecting the drone body and the propulsion unit in order to supply electricity to the propulsion unit.

The structural element 20 can be made up of for example one or more hollow rods, for example of square or round shape, and can be made of plastics or carbon material in order to stiffen the lift-producing wing.

In the absence of a structural element of this type inserted into the lift-producing wing, a groove can be provided in each of the wings in order to allow the routing of the one or more electric wire(s) connecting the drone body and the propulsion unit in order to supply electricity to the propulsion unit.

The lift-producing wings are rigidly connected to the drone body, either directly or indirectly. For example, the lift-producing wings can be bonded to the drone body using a strong adhesive or can be securely retained using a retention mechanism, such as a clip.

As shown in FIG. 2, the lift-producing wings 16 of the drone form a sweep angle a relative to the drone body 12; the sweep angle a may be between 5° and 20°, and preferably approximately 10°.

According to a particular embodiment, each of the propulsion units (apart from the propellers) of the drone is in the same plane as the wing to which it is secured. In other words, each of the propellers on the propulsion units is on a plane that is substantially perpendicular to the plane of the lift surface of the wing to which the propeller is secured.

However, according to the embodiment illustrated in FIG. 1 and in FIG. 4, the four propulsion units form an angle of inclination relative to the horizontal median plane of the drone body, the two propulsion units positioned on one side of the drone body each being inclined towards one another at a predetermined positive vertical angle of inclination and a predetermined negative vertical angle of inclination. Symmetrically, the two propulsion units positioned on the other side of the drone body are each inclined towards one another at the same predetermined positive vertical angle of inclination and the same predetermined negative vertical angle of inclination.

In other words, the propulsion units situated on either side of the drone body above the horizontal median plane of the drone body, when the drone is in the aircraft flight position, are each inclined towards the propulsion units situated on the same side of the drone body below said horizontal median plane at a positive predetermined vertical angle of inclination, and vice versa. The propulsion units situated on either side of the drone body below said horizontal median plane are in particular each inclined towards the propulsion units situated on the same side of the drone body above the horizontal median plane at a symmetrical negative predetermined vertical angle of inclination.

The inclination of the propulsion units allows, in aircraft mode, a horizontal traction component to be created that is perpendicular to the direction of forward movement which contributes to increasing the available torque on the heading axis of the drone, which otherwise would result only from the torque of the propellers on the drone. This increase in torque may have an advantage for flight in aircraft mode, i.e. using the lift of the wings of the drone. This is because the increase in torque allows the displacement inertia of the drone to be counterbalanced on the heading axis in aircraft mode, which inertia is much greater than on a conventional drone, i.e. with no lift-producing wings, owing to the presence of lift-producing wings.

The inclination of the motors leads to a reduction in the lift that is generated, as a portion of the traction produced by the motors is applied on the horizontal plane. However, as such inclination creates a horizontal traction component, this contributes to increasing control of the drone on the heading axis in aircraft mode, as the application of a horizontal force on the lever arm that exists between the motors and the centre of gravity of the drone, optimised by placing propulsion units substantially at the ends of the wings, allows torque to be created on the heading axis which will be added to the torque of the propellers.

The traction needed for the drone to be able to fly in aircraft mode, i.e. using the lift of the wings, is less than the traction needed to allow the drone to maintain a fixed point in its conventional flight configuration, i.e. stationary flight.

It should also be noted that the Z axis of the drone, which corresponds to the heading axis when the drone flies in conventional mode, i.e. using the rotary wing, becomes the roll axis when the drone flies in aircraft mode, i.e. substantially horizontally using the lift of the wings.

According to a particular embodiment, the predetermined angles of inclination of the four propulsion units are identical as an absolute value.

However, according to another embodiment, the propulsion units situated above the horizontal median plane of the drone body, when the drone is in aircraft flight position, may have an angle of inclination as an absolute value that is different from the angles of inclination of the propulsion units situated below said horizontal median plane.

According to a particular embodiment, the predetermined angles of inclination are between 10° and 30°, and preferably about 20°.

It has been noted that the consequence of an angle of inclination of 20° as an absolute value applied to the propulsion units is losses of thrust of approximately 6%. Moreover, the consequence of the circulation of the airflow around the wings when the motors rotate is an increase in the losses of traction owing to the inclination of the propulsion units. Thus, according to this embodiment, the losses of thrust are approximately 24%.

According to a particular embodiment, the propulsion units may be substantially inclined so as to converge on the principal median axis of the drone and may therefore have an angle of inclination value relative to the vertical median plane of the drone body when the drone is in the aircraft flight position.

The drone illustrated in FIGS. 1, 2 and 3 comprises four lift-producing wings secured to the drone body, each wing having the shape of a parallelogram.

However, other wing forms may be envisaged.

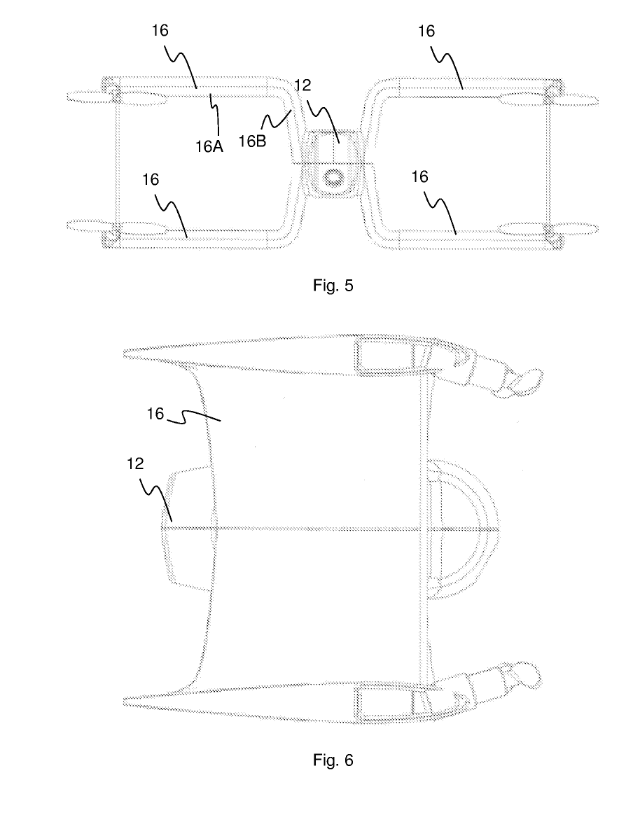

In particular, as shown in FIG. 5, the lift-producing wings can be formed by two portions 16A and 16B, a first portion 16A substantially horizontal to the horizontal median plane of the drone body when the drone is in the aircraft flight position and a portion 16B forming a junction between the substantially horizontal wing portion and the drone body.

According to a still further embodiment shown in FIG. 6, the two link arms located on the upper face of the drone body 12 form a single wing, i.e. a first wing having a seamless suction face and the two link arms on the lower face of the drone body 12 also form a single wing, i.e. a second wing having a seamless suction face.

The lift-producing wings 16 may be connected to each other in pairs by at least one reinforcement means 22.

According to a particular embodiment, the lift-producing wings situated on the same side of the vertical median plane of the drone body, when the drone is in the aircraft flight position, are connected to each other by a reinforcement means 22. FIG. 1 shows an embodiment in which a single reinforcement means is secured between the lift-producing wings on the same side of the drone.

The reinforcement means are made for example of carbon and are respectively securely fixed to two distinct lift-producing wings on either side of the reinforcement means.

According to a particular embodiment, the reinforcement means 22 is fixed substantially close to the propulsion units.

The drone body 12 can further comprise an ultrasonic sensor 24 and/or a camera sensor 26 directed perpendicularly to the plane of the propellers. The purpose of these sensors is to measure, during drone flight in conventional mode, i.e. in rotary-wing mode, the altitude of the drone relative to the ground. The ultrasonic sensor comprises for example an electro-acoustic transducer that allows ultrasounds to be emitted and received. This transducer emits a short burst of ultrasounds of several tens or hundreds of microseconds, then waits for the return of the acoustic echo that is sent following reflection on the ground. The time delay separating the emission of the burst from the reception of the echo allows, knowing the speed of sound, the length of the acoustic path that is covered to be estimated and thus allows the distance separating the drone from the reflective surface to be assessed.

Insofar as the beam of the ultrasonic sensor is relatively wide (typically having a cone with an opening of approximately 55°) and the lift-producing wings are relatively wide and significantly exceed the rear of the drone body, the lift-producing wings reduce the emission and reception cone of the ultrasounds and disrupt the ultrasounds.

In order to improve how to determine the altitude of the drone relative to the ground, a portion of the wings 28 located in the vicinity of the rear portion of the drone body is cut so as to flare-out the space located at the rear of the drone body and to follow the beam cone of the ultrasonic sensor, as shown in FIG. 3.

According to another particular embodiment, the drone may have no wing control surfaces such as aileron-type control surfaces that move and are particularly used to pilot the drone along the three axes thereof, namely the pitch, roll and heading axes. In this case, piloting in aeroplane mode is undertaken by sending specific commands to each propulsion unit of the drone.

When the drone is on the ground, it rests on the ground surface via the drone wings, particularly via the trailing edge of the wings and/or the junction between the trailing edge and the distal end of the wings.

It has been observed that successive drone landings can damage the drone wings.

In order to protect the wings, and according to a particular embodiment, one or more drone wings, and even all the drone wings, can comprise at least one stiffening means 30 over at least one portion of the periphery of the wing so that successive landings do not damage the drone wings.

A drone wing comprising at least one stiffening means will now be described in detail. However, according to the invention, one or more wings, and even all the drone wings, can be designed as described hereinafter.

According to one embodiment, the stiffening means 30 is positioned, for example, at least in part on the distal end and/or on the trailing edge of the wing, as shown in FIG. 3.

Therefore, the stiffening means can be positioned over at least one portion of the length of the distal end of the wing. In a complementary or alternative manner, the stiffening means can be positioned over at least one portion of the length of the trailing edge of the wing.

Alternatively, the wing can comprise a first stiffening means positioned over at least one portion of the length of the distal end of the wing and a second stiffening means over at least one portion of the length of the trailing edge of the wing.

In the case of an embodiment of the drone that comprises arrow-shaped, trapezoidal wings, when the drone is on the ground, it rests on the junction portion between the distal end and the trailing edge of the wings. According to this embodiment, the stiffening means can be at least on the junction portion between the distal end and the trailing edge of the wing in order to prevent any deformation of this end of the wing after several landings.

According to a particular embodiment, the stiffening means is at least in part on the distal end of the wing and extends beyond the distal end to form a drone support element.

According to this particular embodiment, a set of feet is formed on the ends of the wings at the junction between the distal end and the trailing edge of the wings in the extension of the distal end, allowing the drone to land on said feet and thus avoiding any deformation of the wings.

In order to protect the drone wings in the event of frontal impact, the leading edge of one or more drone wing(s) can comprise a stiffening means over all or part of the length of the leading edge of the wing.

The stiffening means are produced from a relatively stiff material, for example, plastics material, particularly polypropylene or high-density expanded polypropylene.

We claim:

1. A rotary-wing drone comprising:
a drone body that comprises an electronic board controlling the piloting of the drone;
four link arms comprising a rigidly connected propulsion unit,
the four link arms forming lift-producing wings,
wherein the drone comprises flight conversion means allowing the drone to perform a conversion after take-off in order to fly using the lift of the four wings.

2. The rotary-wing drone according to claim 1, wherein the propulsion units are fixed at the end of the lift-producing wings.

3. The rotary-wing drone according to claim 1, wherein:
the four propulsion units form an angle of inclination relative to the horizontal median plane of the drone body when the drone is in the aircraft flight position;
the propulsion units situated on either side of the drone body above the horizontal median plane of the drone body, when the drone is in the aircraft flight position, are each inclined towards the propulsion units situated on the same side of the drone body below said horizontal median plane at a positive predetermined vertical angle of inclination; and
the propulsion units situated on either side of the drone body below said horizontal median plane are each inclined towards the propulsion units situated on the same side of the drone body, above the horizontal median plane at a symmetrical negative predetermined vertical angle of inclination.

4. The rotary-wing drone according to claim 3, wherein the predetermined angles of inclination are identical as an absolute value.

5. The rotary-wing drone according to claim 4, wherein the predetermined angles of inclination are between 10° and 30° as an absolute value.

6. The rotary-wing drone according to claim 1, wherein the lift-producing wings positioned on each side of the drone body defined by the horizontal median plane are symmetrical.

7. The rotary-wing drone according to claim 6, wherein the lift-producing wings are dihedral-shaped.

8. The rotary-wing drone according to claim 1, wherein the lift-producing wings are made up of two portions, a first horizontal portion when the drone is in the aircraft flight position and a portion forming a junction between the horizontal wing portion and the drone body.

9. The rotary-wing drone according to claim 1, wherein the lift-producing wings positioned on each side of the drone body are interconnected by at least one reinforcement means.

10. The rotary-wing drone according to claim 9, wherein the reinforcement means is fixed substantially close to the propulsion units.

11. The rotary-wing drone according to claim 1, wherein the lift-producing wings form a sweep angle relative to the drone body.

12. The rotary-wing drone according to claim 1, wherein the drone body is of elongate shape and is substantially perpendicular to a plane of the propellers.

13. The rotary-wing drone according to claim 1, wherein the drone body comprises an ultrasonic sensor and/or a camera sensor directed substantially perpendicularly to a plane of the propellers.

14. The rotary-wing drone according to claim 1, wherein the drone is devoid of a wing control surface.

15. The rotary-wing drone according to claim 1, wherein at least one wing of the drone comprises at least one stiffening means over at least one portion of the periphery of the wing.

16. The rotary-wing drone according to claim 15, wherein said at least one stiffening means is at least in part on the distal end and/or on the trailing edge of said at least one wing.

17. The rotary-wing drone according to claim 15, wherein said at least one stiffening means is located at least on the junction portion between the distal end and the trailing edge of said at least one wing.

18. The rotary-wing drone according to claim 15, wherein said at least one stiffening means is located at least in part on the distal end of said at least one wing and extends beyond said distal end so as to form a support element for the drone.

19. The rotary-wing drone according to claim 15, wherein each wing of the drone comprises said stiffening means.
